(19) United States
(12) Patent Application Publication
(10) Pub. No.: US 2008/0097894 A1
(43) Pub. Date: Apr. 24, 2008

(54) Real-time live and remote integrated auction method

(75) Inventor: Ronaldo de Queiroz Sodre Santoro, Sao Paulo (BR)

Correspondence Address: JONES, TULLAR & COOPER, P.C., P.O. BOX 2266 EADS STATION, ARLINGTON, VA, 22202, US

(73) Assignee: S4B Digital Desenvolvimento De Technologia Multimidia Ltda., Sao Paulo (BR)

(21) Appl. No.: 11/907,978

(22) Filed: Oct. 19, 2007

(30) Foreign Application Priority Data
Oct. 20, 2006 (BR) PI0604683-5

(51) Int. Cl. G06Q 40/00

(52) U.S. Cl. 705/37

(57) ABSTRACT

The present invention relates to an auction method with mixed live and remote participation that seeks to avoid unfavorable conditions for both live bidders at the auction site and remote bidders who access the auction by computerized means. Particularly, the present invention relates to auctions in which some of the bidders have access and participate therein by remote means, particularly via the Internet, landline or mobile telephone, and/or television, and the final part of the auction has no interference from the auctioneer.

### FIELD OF THE INVENTION

The present invention relates to an auction method with mixed live and remote participation, designed to avoid unfavorable conditions for both live bidders at the auction site and remote bidders who access the auction by computerized means. Particularly, the present invention relates to auctions in which some of the bidders have access and participate therein by remote means, particularly via the Internet, landline or mobile telephone, and/or television, and the final part of the auction has no interference from the auctioneer.

### BACKGROUND OF THE INVENTION

Auctions are age-old methods of buying and selling goods. They involve a sequence of bids placed by bidders in relation to a good offered for sale, in a session controlled by an auctioneer, the figure that gives rhythm and life to the event, a kind of animator. The item offered goes to whoever places the highest bid, signaled by the auctioneer who has the authority to close the competition at that point. Until very recently, auctions were limited to the number of bidders who could spare the time or engage an agent to attend the auction site.

A common distortion in auctions is caused by the attitude of the auctioneer, who may favor a particular bidder, by a slip or lack of ethics. Examples of such situation occur when the auctioneer closes the auction of a good, without counting a last higher bid than the prior bid, or allowing some kind of collusion between bidders, so as not to have bids over a certain amount.

With the advent of informatics, many attempts have been presented to solve the issue of access to auctions without the physical presence of the bidders. So far, two kinds of remote auction systems stand out.

The first kind does not have a live auctioneer, and all bidders must be connected to the network or system that provides access to the auction (typically, Internet). In this case, a network computer, or server, in some way substitutes the figure of the auctioneer, accepting bids from the connected audience based on time stamps (access time records) and issuing time receipts for the bid placed. Each bid is accepted or rejected by the server, and the bidder or sometimes the entire audience is notified of this fact, according to pre-established rules. The process is fully computerized, and the items on sale are generally available for the entire duration of the auction and each item is up for bids until a certain time, after which time no more bids are accepted. Distortions occur, as there is a tendency to place the highest bids in the final minutes of the auction, making the rest of the event monotonous compared to a live auction.

The second kind of remote auction system is similar to the first, but the main difference lies in the fact that the items or lots on sale are not available for bidding at the same time, since the focus of the auction moves from one item to another depending on the bidding dynamics and possibly by choice of the auctioneer (live or virtual). Thus, when an item is sold, the auction moves on to the next item in the list.

Below are examples of known computerized auctions, typically via Internet.

North American patent document U.S. Pat. No. 4,789,928 is perhaps the oldest patent document to describe an auction information transmission processing system that allows individuals, from a remote site and not the auction site itself, to participate via computerized means, that is, on-line. The system includes a host computer connected via telecommunication lines to the remote terminals of individual bidders. The individual bidder places bids from his remote terminal and the highest bid is shown in real time to the remote terminals of the other bidders.

An association between the Internet and television is described in an article entitled “Auctions Become High Tech” (Dealer Business, March 1995 V29 N7). This article describes an auction system in which an auction house sends a signal via satellite to television sets of automobile distributors or retailers. When interested in a certain vehicle, these traders place a bid by telephone or by using a terminal associated to the television set.

Another idea aimed at integrating live and remote bidders is described in North American patent U.S. Pat. No. 6,813,612. It basically addresses the adaptation of computer tools so that the usual activity of an auctioneer remains at the center of activities of an auction, including his unilateral decision to accept or reject bids placed by remote bidders.

The present invention differs from everything found in the state of the art, allowing the presence of both live and remote bidders, associated to the auction by any means that allows interaction (television, radio, telephone, private telecommunication channel, pager, etc), and limiting the possibility of situations in which the auctioneer, by a slip or lack of ethics, distorts the workings of the auction in favor of a particular bidder.

With defined rules that allow the remote participation of many bidders (individuals or even companies), with substantial elimination of distortions or prejudice to bidders, such as in this invention, an important incentive is created, in addition to improved cost/benefit, for the sale of goods or service by auction, by they companies, individuals or institutions interested in the effective competition between many more buyers, since this creates barriers to collusion or prior negotiations between buyers or slips by the auctioneer, to-date, sources or lowering the earnings in the sale of auctioned goods.

### DESCRIPTION OF THE INVENTION

The present invention allows the simultaneous presence of live bidders (that is, interacting with the auctioneer at the physical site where the auction is effectively taking place, without the intermediation of electronic means or telecommunication) or remote bidders (that is, those who are not physically present at the event, neither personally nor represented by agents), and at the same time eliminating or minimizing potential distortions through inappropriate conduct by the auctioneer, typically those which unduly favor one or more live bidders, in detriment to the remote bidders.

It is therefore a real-time live and remote integrated auction method, characterized in that:
live and remote bidders have access to the same source of information on one or more goods being auctioned, and the remote bidders do so by means of telecommunication;
remote bidders are distinguished from the live bidders;
the amount of the bids from any bidder, either remote or live, is displayed to all bidders, substantially immediately;
all bidders are informed that the highest bid so far has been overtaken,
once a pre-established ordinary time to receive the best offer for the auctioned good has elapsed, overtime begins, which is a shorter, final period, with countdown; if by the end of the ordinary time the highest bid has been placed by a live bidder, only said bidder will be authorized to place new bids against bids from remote bidders during overtime, optionally restarting countdown when a fresh higher bid is received.

As used in this specification, “source of information” typically means, without excluding any other, a screen accessible by the bidders, indicated herein as an information screen. For live bidders, the screen is displayed at the physical site of the auction, and for remote bidders, a screen is transmitted by telecommunication (for instance the Internet, closed computer network, or television). A bidder takes part in the invention auction both by television transmission coupled to a console that allows interaction with the auction broadcasting station, and by watching the images on television normal, and placing bids by mobile telephone, pager, or any device suitable for this purpose (receipt of these bids can be by a person or computerized system equipped to receive codes).

A remote bidder, as referred to herein, means any bidder whose interaction with the auction event, however partial, is without the direct interaction with the auctioneer. In other words, said remote participation occurs by choice or convenience of the bidder, even when the bidder is physically attending the auction, but interacts (for instance bids) by means of telecommunication, for instance the Internet.

The distinction between remote bidders and live bidders is preferably visual, without excluding any other form. Typically, the bidders are promptly identified as live or remote by different colors on the information screen. Other forms of distinction can be the association of different symbols, shapes (stars, squares, circles, triangles, etc.), groups of geometric shapes, different location on the information screen, association through different human pictures, association through alphanumeric codes, combinations of any of these alternatives and with others, etc.

Bidders may, at their discretion, be identified by names or codes, which enable them to be identified, or adopt codenames which prevents their identification.

Preferably, the bidders are subject to prior registration and/or authorization to take part in the auction, for the security of the institution organizing or sponsoring the auction.

The bids can be appraised before or after they are received for compliance with the pre-established rules, for example, qualification of the bidder.

The quantity and amount of the bids placed by each bidder are substantially immediately displayed on the information screen, for simultaneous transmission to all. If necessary, procedures can be introduced to avoid substantial delays in the means of telecommunication involving the auction, prejudicing or favoring the different kinds of bidders, remote or live.

When a new higher bid is received, it is highlighted, by any means possible, particularly by intermittent display of the amount on the information screen. Any other means of display is suitable, such as a change of color, change of location on the screen, appearance of a picture indicating change, association with any symbols or shapes, etc. Optionally, sound can be associated to the arrival event of a new higher bid, particularly for remote bidders.

The voice of the auctioneer, obviously accessible by the live bidders, may or may not be received by the remote bidders.

According to this invention, at a certain point in the auction, a final phase begins, which is overtime, with countdown, typically lasting some minutes. During this phase, the auctioneer no longer interacts with the bidders, who can only place new bids via remote means. To avoid collusion between live bidders or any prejudicial intervention by the auctioneer, only the live bidder who placed the highest bid, by the end of the ordinary period, continues participating in the final phase. One or more overtime periods, that is, one or more subsequent fresh countdowns are optionally begun, having the same duration, or a different duration, for example a shorter duration, if a new higher bid is placed. The number of overtime periods, with the restart of countdown, is freely chosen, and may vary from 1 to x. Typically there are less than 10 fresh countdown restarts, since the disputed good reaches a certain amount that inhibits the endless continuation of the competition. Particularly, the start (or restart) of overtime, with countdown, is associated to a certain identification symbol, particularly a small clock.

The final period for accepting bids, wherein the highest bid wins, after the last overtime, with countdown, is also preferably displayed to all bidders by a certain signal, particularly a visual sign, for example an intermittent color display, or equivalent.

Advantageously, an auction according to the invention is held with a large number of goods, associated in lots. An auction may have a large number of lots, for instance some hundreds of lots. A didactic example of a good to be auctioned is a telephone set, wherein a lot would comprise a quantity of telephone sets having similar characteristics, and during the auction there are other lots of other goods, for example, computers, monitors, keyboards, mouse devices, printers, etc. Any kind of good or service can be the object of the auction of this invention.

When the invention auction comprises many lots, the information screen is particularly split into as many sub-screens as necessary to identify or supply information on said lots. Advantageously, a remote bidder, for instance, via the Internet or computer network, may set up a screen that only displays information on the lots of interest to him, excluding all other lots. For example, in an auction of industrial scrap, the bidder wants only parts containing copper. Said bidder sets up his screen to show only the lots of interest to him without diverting his attention to the other lots.

A typical information screen comprises 15 simultaneous sub-screens, relating to 15 lots, for example five horizontal sub-screens or 3 vertical sub-screens. Said lots are normally presented in sequential numerical order, and their respective sub-screens are withdrawn from the main screen as and when the highest bid is placed, once both ordinary time and overtime have run their course. Each sub-screen bears selective information on the lot displayed thereon, and a bidder may obtain more complete information, for example by clicking on a particular point of the sub-screen, and navigating through new screens that open up and provide the data requested, with photos, quality and quantity of the lot goods, site of location of the goods, etc.

Advantageously, the information screen of the invention auction may be set up to contain more or less information. For example, without excluding other embodiments, within a particular embodiment where there are many lots in the same auction, the following information appears in an upper section of the main screen. Said information may change over time, as applicable:
Identification of the auctioneer or company holding the auction;
Current time and time elapsed since the start of the auction;
Icons to choose the set-up of number of sub-screens, or screens available;
Total number of bids placed in all lots;
The grand total of all the highest bids of the lots already sold.

Also in a particular embodiment, without excluding any others, for each sub-screen associated to a lot, the following information, for example, is available:
Number of lot;
Description of lot;
Indication of time remaining to place bids;
An icon allowing navigation to other screens with further information on the goods in a specific lot;
Identification of bidder who placed the highest bid;
Number of bids placed in a specific lot;
Minimum increase amount between each bid;
Classification XXX;
Percentage to the paid to the auctioneer.

As in any traditional auction, without restricting the scope of this present invention, the auctioneer may combine two or more lots into one, or synchronize the time remaining to receive bids for two or more similar lots.

The main information screen may also contain information displayed on a rolling ticker, and the ticker and/or information can roll in any direction, preferably horizontally for ease of reading, without excluding the horizontal, diagonal or any other ticker. Optionally, one or more rolling tickers are used.

The present invention also comprises alternative embodiments aimed at stimulating or facilitating the participation of buyers. For example, certain bidders, categorized as the most important, only take part during overtime, or have an advantage for having placed bids near to the highest ones, or have access to information that the other bidders do not, for example, an indication that a certain lot is a good purchase option by virtue of its nobler origin, etc.

When the invention auction involves television transmission, optionally the remote bidder may choose between different cameras at the physical site of the auction, or at sites where more than one camera has been installed.

It is quite clear from the description of this invention that the use of electronic means and telecommunication are essential for its embodiment, though the technical specification of devices of this nature are not necessary, nor do they limit the scope of this invention, as opposed to their effect, which is practical and brings concrete results that would not be possible without them. More people can participate in the auction due to the ease of access, without physically needing to go to the auction site, increased security through the non-interference of a human hand in the final phase, and greater equality of footing between remote and live participation—said characteristics grounded on technology result, secondarily, in improved efficiency in holding an auction, and consequently higher sales amounts for the auctioned goods or services.

We claim:

1. An integrated auction method with mixed real-time live and remote participation comprising,
a) providing access to the same source of information on the goods being auctioned to live bidders and remote bidders, said remote bidders are provided access by means of telecommunication;
b) distinguishing remote bidders from live bidders;
c) displaying to live bidders and remote bidders, substantially immediately, the bid amount of any bidder, either remote or live;
d) providing an indication that a highest offer so far has been overtaken;
e) proceeding to overtime after a pre-established ordinary time to receive a best offer for the auctioned good has elapsed, said overtime begins with a countdown; and
f) authorizing only a live bidder who has placed the best offer at the end of the pre-established ordinary time to place new bids against bids from remote bidders participating in overtime.

2. The method of claim 1, further comprising restarting the overtime one or more times when a new higher bid is received resulting in a fresh overtime countdown.

3. The method of claim 2, wherein each fresh overtime countdown has a different duration.

4. The method of claim 2, wherein each fresh overtime countdown has a shorter duration.

5. The method of claim 1, wherein the source of information is a screen that is visible to the bidders.

6. The method of claim 1, wherein the step of distinguishing between live and remote bidders is a visual distinction.

7. The method of claim 6, wherein the visual distinction between live and remote bidders is selected from the group consisting of different colors, different symbols, different shapes, association to different pictures, different alphanumeric codes and different location on the information screen.

8. The method of claim 1, further comprising allowing the bidders to choose their codenames.

9. The method of claim 1, further comprising subjecting the bidders to prior registration and/or authorization to take part in the auction.

10. The method of claim 1, wherein said step of providing an indication that a highest offer so far has been overtaken is displayed to all the auction bidders on an information screen.

11. The method of claim 10, wherein said information screen is chosen by intermittent display of the amount, change of color, change of location on the screen, appearance of image indicating change, association with symbols or shapes and sound.

12. The method of claim 1, wherein the overtime countdown is associated to a figure of a clock.

13. The method of claim 2, wherein each fresh overtime countdown is associated to a figure of a clock.

14. The method of claim 1, wherein the remote bidders are provided access by one or more means selected from the group consisting of internet, computer network, landline or mobile telephone, pager, radio and television.

14. The method of claim 2, wherein the remote bidders are provided access by one or more means selected from the group consisting of internet, computer network, landline or mobile telephone, pager, radio and television.

15. The method of claim 5, wherein the remote bidders are provided access by one or more means selected from the group consisting of internet, computer network, landline or mobile telephone, pager, radio and television.

16. The method of claim 6, wherein the remote bidders are provided access by one or more means selected from the group consisting of internet, computer network, landline or mobile telephone, pager, radio and television.

17. The method of claim 7, wherein the remote bidders are provided access by one or more means selected from the group consisting of internet, computer network, landline or mobile telephone, pager, radio and television.

18. The method of claim 10, wherein the remote bidders are provided access by one or more means selected from the group consisting of internet, computer network, landline or mobile telephone, pager, radio and television.

19. The method of claim 14, wherein the remote bidders are provided access by means of the Internet.

20. The method of claim 14, wherein the remote bidders are provided access by means of a combination of television and mobile telephone.
